(19) United States
(12) Patent Application Publication
(10) Pub. No.: US 2019/0278798 A1
(43) Pub. Date: Sep. 12, 2019

(54) TERMINAL DEVICE, METHOD, AND INFORMATION PROCESSING SYSTEM

(71) Applicant: Hidenobu KISHI, Kanagawa (JP)

(72) Inventor: Hidenobu KISHI, Kanagawa (JP)

(21) Appl. No.: 16/284,206

(22) Filed: Feb. 25, 2019

(30) Foreign Application Priority Data
Mar. 6, 2018 (JP) 2018-040132

(51) Int. Cl. G06F 16/532; G06F 16/58; G06F 21/30; G06T 1/00

(52) U.S. Cl. CPC G06F 16/532; G06T 1/0007; G06F 21/30; G06F 16/5866

(57) ABSTRACT

A terminal device includes circuitry configured to perform: transmitting a captured image to a search device configured to acquire link information associated with an image based on the image; managing a predetermined storage area of a memory configured to store data; receiving the link information transmitted from the search device in accordance with the captured image; authenticating including referring to the predetermined storage area in accordance with the link information received at the receiving, to determine whether authenticated authentication information is stored in the predetermined storage area; and access-controlling including permitting access to predetermined information in response to determination, at the authenticating, that the authenticated authentication information is stored in the predetermined storage area.

### CROSS-REFERENCE TO RELATED APPLICATIONS

The present application claims priority under 35 U.S.C. § 119 to Japanese Patent Application No. 2018-040132, filed on Mar. 6, 2018. The contents of which are incorporated herein by reference in their entirety.

### BACKGROUND OF THE INVENTION

### 1. Field of the Invention

The present invention relates to a terminal device, a method, and an information processing system.

### 2. Description of the Related Art

For example, an image search technology for extracting a feature point from a captured image that is obtained by capturing an image by a camera, and searching for an image that has a large number of similar feature points from an image group that is registered in advance has been known. A technology for, with use of the image search technology as described above, registering an image of a specific photograph or printed material in a database in association with various kinds of electronic data, searching for a similar image from the database by using a captured image that is obtained by imaging the photograph or the printed material, and providing electronic data associated with the similar image has been known (for example, Japanese Patent Application Laid-open No. 2014-010723).

In addition, Japanese Patent Application Laid-open No. 2016-012207 describes an information processing system that acquires a uniform resource locator (URL), an event code, a medium code, and a device ID for identifying a device that has performed imaging, on the basis of an image captured by a camera, performs authentication using the medium code and the device ID at an access destination indicated by the URL, and acquires contents corresponding to the event code when the authentication is successful. According to the information processing system described in Japanese Patent Application Laid-open No. 2016-012207, it is possible to provide limited contents to a user who has purchased the medium.

Meanwhile, in some cases, it is desired to provide different contents for each of users based on the same image. For example, there may be a service for providing contents including an image of each of users to each of the users based on an image of the same pamphlet or the like at an event or a sightseeing area. However, in the conventional technology, there is a problem in that it is difficult to provide different information to each of users based on common information. For example, in Japanese Patent Application Laid-open No. 2016-012207 as described above, while it is possible to provide limited contents to purchasers of media, it is impossible to provide different contents to each of users based on the same medium.

### SUMMARY OF THE INVENTION

According to one aspect of the present invention, a terminal device includes circuitry configured to perform: transmitting a captured image to a search device configured to acquire link information associated with an image based on the image; managing a predetermined storage area of a memory configured to store data; receiving the link information transmitted from the search device in accordance with the captured image; authenticating including referring to the predetermined storage area in accordance with the link information received at the receiving, to determine whether authenticated authentication information is stored in the predetermined storage area; and access-controlling including permitting access to predetermined information in response to determination, at the authenticating, that the authenticated authentication information is stored in the predetermined storage area.

### BRIEF DESCRIPTION OF THE DRAWINGS

FIG. 1 is a diagram schematically illustrating a configuration of an information processing system according to a first embodiment;

FIG. 2 is a block diagram illustrating an example of a configuration of an image search server that is applicable to each of embodiments;

FIG. 3 is an exemplary functional block diagram for explaining functions of the image search server that is applicable to each of the embodiments;

FIG. 4 is a block diagram illustrating an example of a configuration of a terminal device that is applicable to each of the embodiments.

FIG. 5 is an exemplary functional block diagram for explaining functions of the terminal device according to the first embodiment;

FIG. 6 is a diagram for explaining a process performed by the information processing system according to the first embodiment;

FIG. 7 is a sequence diagram illustrating an example of a process performed by the information processing system according to the embodiment;

FIGS. 8A and 8B are diagrams each illustrating an example of an input screen that is displayed by an authentication unit and that is applicable to the first embodiment;

FIG. 9 is a sequence diagram illustrating an example of a process of disabling authentication of an authenticated PIN according to the first embodiment;

FIG. 10 is a block diagram illustrating an example of a configuration of an information processing system that is applicable to a first modification of the first embodiment;

FIG. 11 is a diagram for explaining a process performed by an information processing system according to the first modification of the first embodiment;

FIG. 12 is a diagram illustrating an example of a process that is performed when it is determined that an authenticated PIN is not stored in a cache of a terminal device according to the first modification of the first embodiment;

FIG. 13 is a sequence diagram illustrating an example of a process performed by the information processing system according to the first modification of the first embodiment;

FIG. 14 is a block diagram illustrating an example of a configuration of an information processing system according to a second modification of the first embodiment;

FIG. 15 is a diagram illustrating an example of a questionnaire screen that is displayed on a terminal device by an external service server;

FIG. 16 is a sequence diagram illustrating an example of a process performed by an information processing system according to the second modification of the first embodiment;

FIG. 17 is a block diagram illustrating an example of a configuration of an information processing system according to a second embodiment;

FIG. 18 is a block diagram illustrating an example of a configuration of a terminal device according to the second embodiment;

FIG. 19 is a flowchart illustrating an example of a process of generating an app ID according to the second embodiment;

FIG. 20 is a sequence diagram illustrating an example of a process performed by the information processing system according to the second embodiment; and

FIG. 21 is a sequence diagram illustrating an example of a process performed by an information processing system according to a first modification of the second embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to make it possible to provide different information based on common information.

Exemplary embodiments of a terminal device, a computer-readable medium, and an information processing system will be described in detail below with reference to the accompanying drawings.

### First Embodiment

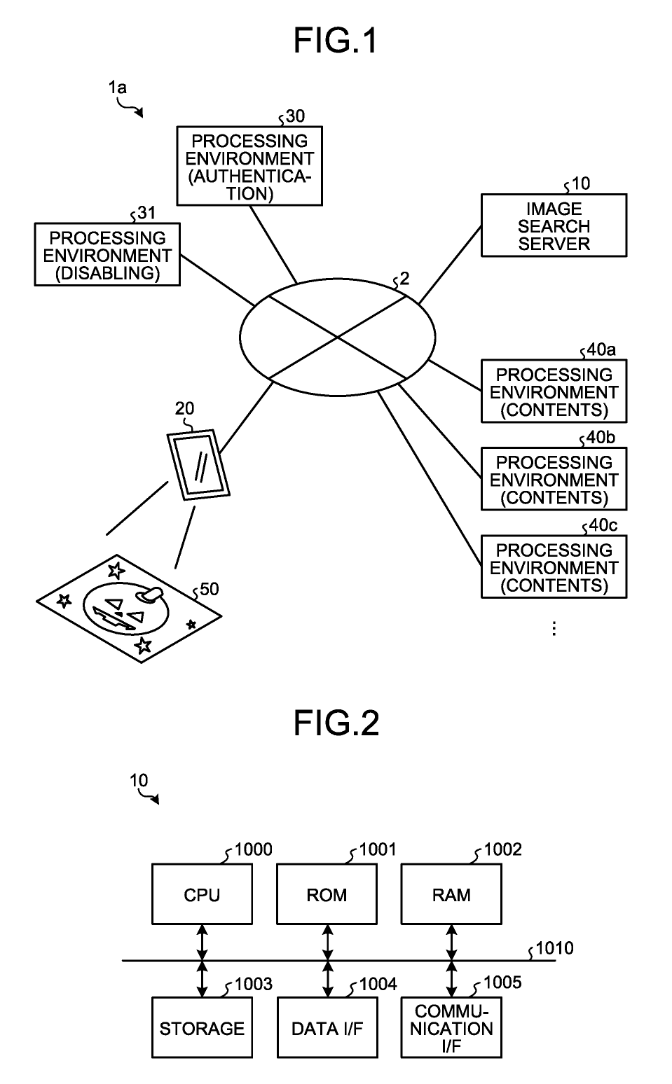

FIG. 1 is a diagram schematically illustrating a configuration of an information processing system according to a first embodiment. In FIG. 1, an information processing system 1a includes an image search server 10, a terminal device 20, a processing environment 30, a processing environment 31, and processing environments 40a, 40b, 40c, . . . , all of which are connected to a network 2, such as the Internet. The terminal device 20 is, for example, an information processing apparatus, such as a tablet computer or a multifunctional mobile phone terminal (smartphone), which has an imaging function and is easily portable, and performs wireless communication with the network 2.

The processing environment 30 is, for example, a Web server, and a uniform resource locator (URL) (A) is assigned thereto as address information. While details will be described later, the processing environment 30 provides, to the terminal device 20, an environment for performing an authentication process when the terminal device 20 acquires contents. Similarly, a URL(B) is assigned, as address information, to the processing environment 31 that is a Web server for example, and the processing environment 31 provides, to the terminal device 20, an environment for disabling authentication that has been performed by the processing environment 30.

While the processing environments 30 and 31 are illustrated as separate Web servers in FIG. 1 for the sake of explanation, the embodiments are not limited to this example. In other words, it may be possible to assign different URLs on the same Web server to the processing environments 30 and 31.

Each of the processing environments 40a, 40b, 40c, . . . is, for example, a Web server, and a URL(1), a URL(2), a URL(3), . . . is assigned thereto as address information. The processing environments 40a, 40b, 40c, . . . provide, to the terminal device 20, processes that are performed when the terminal device 20 acquires contents. Hereinafter, the processing environments 40a, 40b, 40c, . . . are limited to the three processing environments 40a, 40b, and 40c, and the processing environment 40a will be described as a representative of them unless otherwise specified.

The image search server 10 includes one or more information processing apparatuses, and a database in which feature information on an image and link information that is information linked with the image are stored and registered in an associated manner. The image search server 10 extracts feature information by analyzing an image, and acquires the link information that is stored and registered in the databased in association with the extracted feature information. For example, it is possible to apply a search device as disclosed in Japanese Patent Application Laid-open No. 2014-010723 as the image search server 10. Further, it is possible to apply information (for example, a URL) indicating a position on the network 2 as the link information. Hereinafter, the explanation will be given based on the assumption that the link information is an URL unless otherwise specified.

For example, feature information and link information on an image included in a photographic subject 50 are registered in an associated manner in the database of the image search server 10. The terminal device 20 captures an image of the photographic subject 50 using the imaging function, and transmits the captured image and a search request to the image search server 10 via the network 2. The image search server 10 extracts feature information by analyzing the captured image in accordance with the search request, and transmits, to the terminal device 20, the link information that is registered in association with the extracted feature information by referring to the database. The terminal device 20 is able to access, for example, the processing environment 30 by using, as access destination information, a URL that is indicated by the link information transmitted from the image search server 10.

FIG. 2 is a block diagram illustrating an example of a configuration of the image search server 10 that is applicable to each of the embodiments. In FIG. 2, it is assumed that the image search server 10 is configured as a single information processing apparatus. In FIG. 2, the image search server 10 includes a central processing unit (CPU) 1000, a read only memory (ROM) 1001, a random access memory (RAM) 1002, a storage 1003, a data interface (I/F) 1004, and a communication I/F 1005, all of which are connected to a bus 1010.

The storage 1003 is a hard disk drive or a flash memory, and stores therein data in a non-volatile manner. The CPU 1000 controls entire operation of the image search server 10 in accordance with a program that is stored in advance in the storage 1003 and the ROM 1001 by using the RAM 1002 as a working memory. The data I/F 1004 is an interface for transmitting and receiving data to and from an external information apparatus, and, for example, a universal serial bus (USB) may be adopted. The communication I/F 1005 performs communication via the network 2 under the control of the CPU 1000.

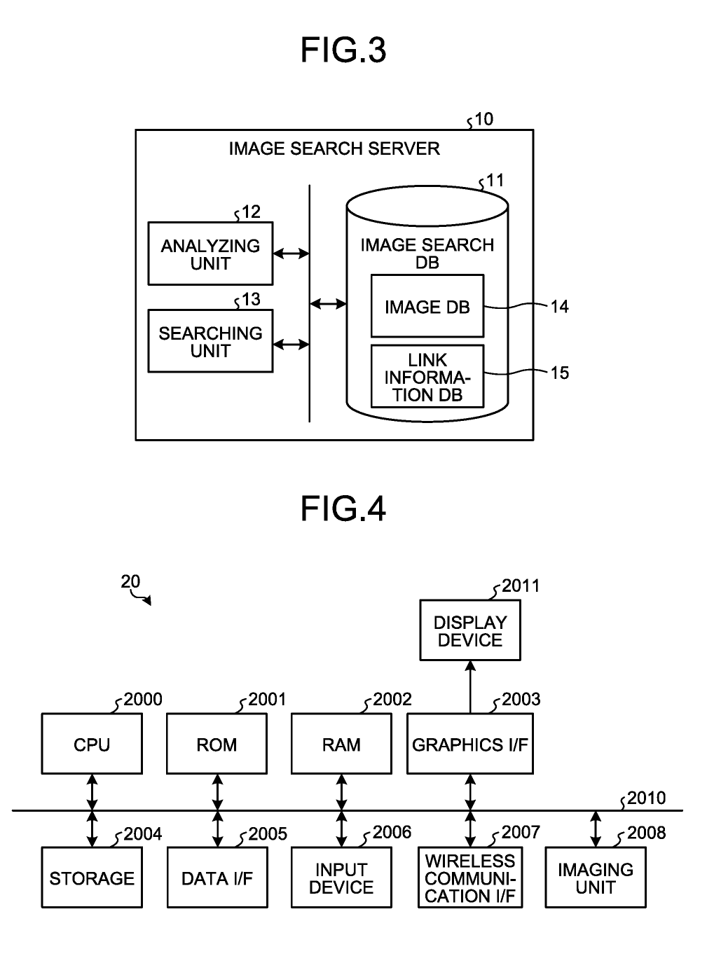

FIG. 3 is an exemplary functional block diagram for explaining functions of the image search server 10 that is applicable to each of the embodiments. In FIG. 3, the image search server 10 includes an image search database (DB) 11, an analyzing unit 12, and a searching unit 13. The image search DB 11 includes an image DB 14 and a link information DB 15. In the image DB 14, images are registered in a searchable manner. In the link information DB 15, link information that is linked with the images registered in the image DB 14 is registered in association with the images.

As the image search DB 11, for example, a predetermined storage area in the storage 1003 included in the image search server 10 is applicable; however, the embodiments are not limited to this example. The image search DB 11 may be configured using a storage area of an external storage device that is connected to the image search server 10 via the data I/F 1004 or the communication I/F 1005.

An image registration process is performed by the image search server 10 as summarized below. The image search server 10 causes the analyzing unit 12 to analyze an image to be registered, and extracts feature information indicating a feature of the image. The image search server 10 stores the extracted feature information in the image DB 14 in association with image identification information for identifying the image. Further, the image search server 10 stores link information to be provided to a user in the link information DB 15 in association with the image identification information. By respectively storing the image (feature information) and the link information in the image DB 14 and the link information DB 15 in association with the image identification information, the image is registered in the image search DB 11.

An image search process is performed by the image search server 10 as summarized below. For example, the image search server 10 receives an image transmitted from the terminal device 20, and sends the received image to the analyzing unit 12 via the searching unit 13. The analyzing unit 12 analyzes the sent image, extracts feature information from the image, and sends the extracted feature information to the searching unit 13. The searching unit 13 searches through the image DB 14 for feature information that has a high similarly to the feature information sent from the analyzing unit 12 on the basis of the sent feature information. The searching unit 13 acquires, from the link information DB 15, link information that is associated with the image identification information corresponding to the retrieved feature information. The image search server 10 transmits, as a search result, the link information acquired from the link information DB 15 to the terminal device 20.

FIG. 4 is a block diagram illustrating an example of a configuration of the terminal device 20 that is applicable to each of the embodiments. In FIG. 4, the terminal device 20 includes a CPU 2000, a ROM 2001, a RAM 2002, a graphics I/F 2003, a storage 2004, a data I/F 2005, an input device 2006, a wireless communication I/F 2007, and an imaging unit 2008, all of which are connected to a bus 2010. Thus, the terminal device 20 is an information processing apparatus on which a computer including the CPU 2000, the ROM 2001, and the RAM 2002 is mounted.

The storage 2004 is a storage medium capable of storing data in a non-volatile manner, and is, for example, a non-volatile semiconductor memory, such as a flash memory. However, the embodiments are not limited to this example, and a hard disk drive may be used as the storage 2004. The storage 2004 stores therein a program to be executed by the CPU 2000 and various kinds of data. Meanwhile, a single rewritable non-volatile semiconductor memory or the like may be used as both of the storage 2004 and the ROM 2001, for example.

The CPU 2000 controls the entire terminal device 20 in accordance with programs stored in the ROM 2001 and the storage 2004 by using the RAM 2002 as a working memory. The graphics I/F 2003 converts a display control signal generated by the CPU 2000 to a signal that can be displayed by a display device 2011, and outputs the converted signal. The display device 2011 includes, for example, a liquid crystal display (LCD), and performs display in accordance with the display control signal by being driven by a signal that is output by the graphics I/F 2003.

The data I/F 2005 performs data input and output with respect to an external apparatus. As the data I/F 2005, for example, an interface, such as a universal serial bus (USB) or Bluetooth (registered trademark), may be adopted.

The input device 2006 receives input from a user. The user is able to issue an instruction to the terminal device 20 by operating the input device 2006 in accordance with display on the display device 2011, for example. It is preferable that the input device 2006 and the display device 2011 are constructed in an integrated manner and configured as a touch panel that outputs a control signal corresponding to a pressed position and transmits an image of the display device 2011.

The wireless communication I/F 2007 performs communication via the network 2 as wireless communication under the control of the CPU 2000.

The imaging unit 2008 includes an optical system, an imaging element, and a control driving circuit for the optical system and the imaging element, performs a predetermined process on an imaging signal output from the imaging element, and output a captured image based on a digital signal. The captured image that is subjected to the image processing and output by the imaging unit 2008 may be stored in, for example, the storage 2004. Further, the CPU 2000 is able to read the captured image from the storage 2004 and transmit the captured image to the network 2 via the wireless communication I/F 2007.

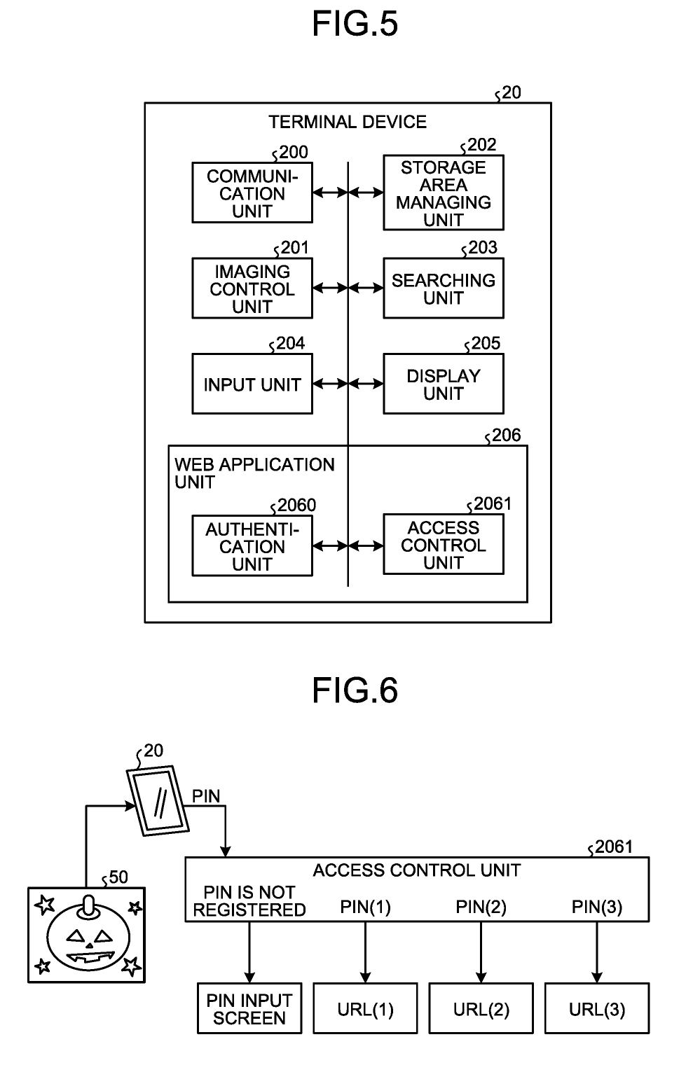

FIG. 5 is an exemplary functional block diagram for explaining functions of the terminal device 20 according to the first embodiment. In FIG. 5, the terminal device 20 includes a communication unit 200, an imaging control unit 201, a storage area managing unit 202, a searching unit 203, an input unit 204, a display unit 205, and a Web application unit 206.

The communication unit 200, the imaging control unit 201, the storage area managing unit 202, the searching unit 203, the input unit 204, the display unit 205, and the Web application unit 206 are configured by causing the CPU 2000 to execute an information processing program according to the first embodiment. However, the embodiments are not limited to this example, and a part or all of the communication unit 200, the imaging control unit 201, the storage area managing unit 202, the searching unit 203, the input unit 204, the display unit 205, and the Web application unit 206 may be configured using hardware circuits that operate in a cooperative manner.

The communication unit 200 controls communication over the network 2. The imaging control unit 201 controls imaging operation of the imaging unit 2008 and acquires a captured image. The storage area managing unit 202 manages a predetermined storage area on the storage 2004 as an area to be used exclusively for the information processing program. Hereinafter, the storage area managed by the storage area managing unit 202 will be referred to as a cache.

The searching unit 203 causes the communication unit 200 to transmit the captured image acquired by the imaging control unit 201 and a search request to the image search server 10, and requests the image search server 10 to search for an image based on the captured image. Further, the searching unit 203 causes the communication unit 200 to acquire link information that is obtained by the image search server 10 through the search based on the search request, via the network 2.

The input unit 204 receives user operation on the input device 2006 and generates input information corresponding to the user operation. The display unit 205 generates display control information for causing the display device 2011 to perform display.

The Web application unit 206 includes an engine for executing a predetermined program (script), analyzes a script that is written in, for example, a hypertext markup language (HTML) file that is loaded from a Web server, and implements functions based on the script. In the first embodiment, the Web application unit 206 implements functions of an authentication unit 2060 and an access control unit 2061 on the basis of the script.

As the script that is executable by the Web application unit 206, JavaScript (registered trademark) may be adopted, for example.

The authentication unit 2060 performs an authentication process by referring to the cache managed by the storage area managing unit 202 on the basis of authentication information. For example, the authentication unit 2060 performs the authentication by using, as the authentication information, a personal identification number (PIN) that is a combination of numbers of a few digits. The authentication information that is applicable to the authentication process performed by the authentication unit 2060 is not limited to the PIN, and a password that is a combination of alphanumeric characters and signs may be used as the authentication information, for example. Further, when new authentication information is authenticated, the authentication unit 2060 writes the new authentication information in the cache. Furthermore, the authentication unit 2060 performs a process of deleting authentication information that has been written in the cache.

The authentication unit 2060 stores the authentication information, link information (URL), and authentication complete information indicating completion of authentication in the cache in advance. Table 1 is an example of an authentication table which is stored in the cache and in which the authentication information, the link information, and the authentication complete information are associated with one another.

TABLE 1

| PIN | URL | FLAG |
|---|---|---|
| PIN(1) | URL(1) | 1 |
| PIN(2) | URL(2) | 0 |
| PIN(3) | URL(3) | 0 |
| . | . | . |
| . | . | . |
| . | . | . |

As illustrated in Table 1, the authentication table contains an item “PIN”, an item “URL”, and an item “FLAG”. Among these items, the item “URL” stores therein a URL as the link information. The item “FLAG” stores therein the authentication complete information, where a value “1” indicates that authentication for a PIN is completed, and a value “0” indicates that authentication is not completed. Each of the values stored in the authentication table is written in advance in a script for generating the authentication unit 2060, for example. Meanwhile, it is assumed that an initial value of the item “FLAG” is “0”.

In the example of Table 1, in the authentication table, a PIN(1), a PIN(2), and a PIN(3) are stored in the item “PIN”, and a URL(1), a URL(2), and a URL(3) are stored in the item “URL” in association with the PIN(1), the PIN(2), and the PIN(3), respectively. Further, in the item “FLAG”, a value “1” indicating completion of authentication is set for the PIN(1), and a value “0” indicating non-completion of authentication is stored in the PIN(2) and the PIN(3).

The access control unit 2061 controls access of the terminal device 20 to an access destination via the network 2 in accordance with an authentication result obtained by the authentication unit 2060. For example, if the authentication unit 2060 determines that authentication is successful, the access control unit 2061 permits access to predetermined information. Further, if the authentication unit 2060 determines that authentication has failed, the access control unit 2061 generates, for example, an input screen for inputting correct authentication, and causes the display unit 205 to display the input screen.

In the example illustrated in FIG. 5 and FIG. 1 as described above, the terminal device 20 reads an HTML file in which a script for generating the authentication unit 2060 is written from the processing environment 30 that is a Web server. Further, the terminal device 20 reads an HTML file in which a script for generating the access control unit 2061 is written from the processing environment 40 that is a Web server. With this operation, the Web application unit 206 generates the authentication unit 2060 and the access control unit 2061 on the terminal device 20.

The information processing program for executing processes according to the first embodiment is provided by being recorded in a computer-readable recording medium, such as a compact disk (CD) or a digital versatile disk (DVD), in a computer-installable or computer-executable file format. However, the embodiments are not limited to this example, and the information processing program for executing the processes according to the first embodiment may be provided by being stored in a computer that is connected to a communication network, such as the Internet (for example, the network 2), and downloaded via the communication network. Furthermore, the information processing program for executing the processes according to the first embodiment may be provided or distributed via a communication network, such as the Internet.

The information processing program for executing the processes according to the first embodiment has, for example, a module structure including the above-described units (the communication unit 200, the imaging control unit 201, the storage area managing unit 202, the searching unit 203, the input unit 204, the display unit 205, and the Web application unit 206). As actual hardware, by causing the CPU 2000 to read the search program from, for example, a storage device and execute the program, the above-described units are loaded on a main storage device (for example, the RAM 2002), and each of the units is generated on the main storage device.

Outline of a process of the first embodiment

Next, the outline of a process performed by the information processing system 1a according to the first embodiment will be described. FIG. 6 is a diagram for explaining a process performed by the information processing system 1a according to the first embodiment. In FIG. 6, the same components as those illustrated in FIG. 1 as described above are denoted by the same reference signs, and detailed explanation thereof will be omitted. In addition, the image search server 10 is omitted in FIG. 6 for the sake of simplicity.

The terminal device 20 captures an image of the photographic subject 50 that is prepared in advance and that includes an authentication key image, and transmits the captured image and a search request to the image search server 10. The terminal device 20 reads a script by accessing the processing environment 30 in accordance with link information that is retrieved by the image search server 10 in response to the search request, and generates the authentication unit 2060. The authentication unit 2060 refers to the authentication table that is stored in the cache of the terminal device 20 for example, and determines whether an authenticated PIN is stored in the cache of the terminal device 20. If it is determined that the authenticated PIN is stored, the access control unit 2061 permits access to a URL that is stored in the cache in association with the PIN.

In the example in FIG. 6, the URL(1), the URL(2), and the URL(3) are associated with the PIN(1), the PIN(2), and the PIN(3), respectively. If the authenticated PIN is the PIN(1) for example, the access control unit 2061 permits access to the URL(1). Similarly, if the authenticated PIN is the PIN(2) or the PIN(3), the access control unit 2061 permits access to the URL(2) or the URL(3).

If the authentication unit 2060 determines that an authenticated PIN is not stored in the cache, the access control unit 2061 determines that a PIN is not yet authenticated, and causes the display unit 205 to display an input screen for inputting a PIN. If an input value that is input to the input screen is a correct value, the authentication unit 2060 determines that a PIN corresponding to the input value is an authenticated PIN. For example, the authentication unit 2060 determines that the input value is a correct value when a PIN that matches the input pin is stored in the authentication table by referring to the authentication table based on the input value.

In this manner, in the information processing system la according to the first embodiment, it is possible to provide different contents (URLs) based on the same key image.

Details of the process according to the first embodiment

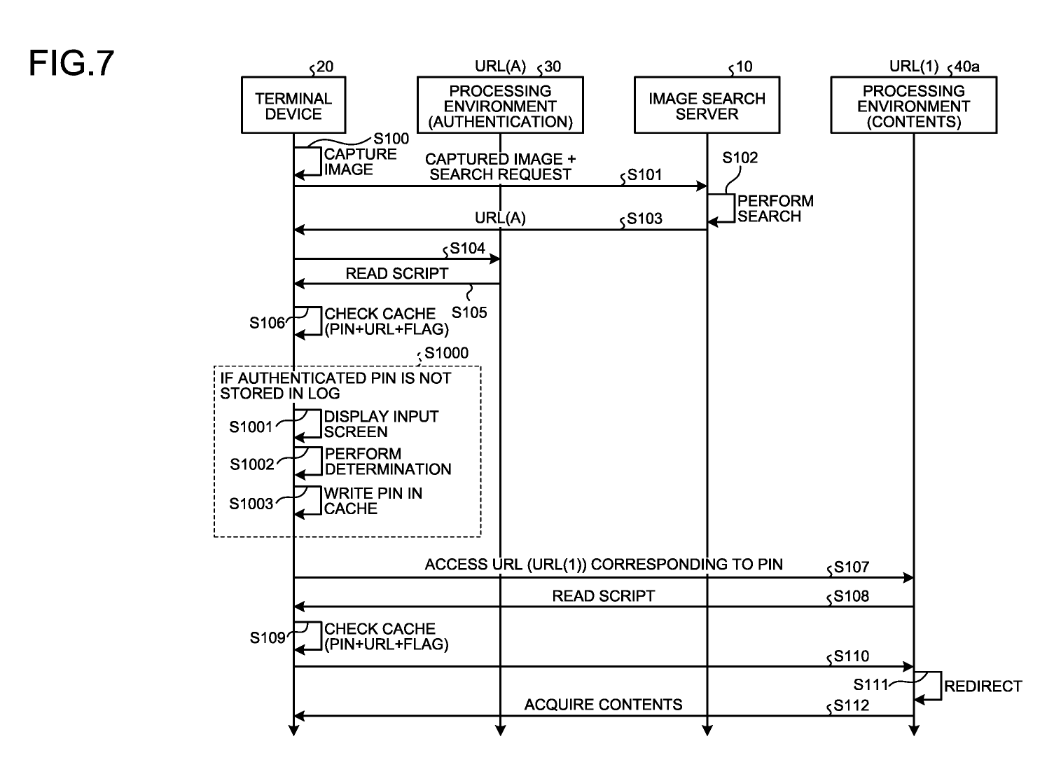

The process according to the first embodiment will be described in detail below. FIG. 7 is a sequence diagram illustrating an example of a process performed by the information processing system 1a according to the embodiment. In FIG. 7, the same components as those illustrated in FIG. 1 as described above are denoted by the same reference signs, and detailed explanation thereof will be omitted.

A user captures an image of the photographic subject 50 including the key image by operating the terminal device 20 (Step S100). The key image is an authentication key image for permitting the terminal device 20 to acquire contents, for example. The terminal device 20 transmits the captured image including the captured key image and a search request to the image search server 10 (Step S101).

The image search server 10 receives the captured image and the search request transmitted from the terminal device 20, performs a search based on the captured image in response to the received search request, and acquires link information that is associated with the key image included in the captured image (Step S102). The link information acquired at this time is the URL(A) that is access destination information on the processing environment 30 for performing authentication. The image search server 10 returns the acquired link information (URL(A)) to the terminal device 20 (Step S103).

Upon receiving the link information, i.e., the URL(A), transmitted by the image search server 10, the terminal device 20 accesses the processing environment 30 in accordance with the received URL(A) (Step S104), and reads a script (Step S105). The terminal device 20 generates the authentication unit 2060 based on the read script. The script includes, for example, the PIN(1), the PIN(2), the PIN(3) and the URL(1), the URL(2), the URL(3) that correspond to the processing environments 40a, 40b, 40c, respectively.

The terminal device 20 causes the authentication unit 2060 to check the cache and determines whether an authenticated PIN is stored in the authentication table that is stored in the cache (Step S106). For example, the authentication unit 2060 searches for a PIN for which the value of “1” is stored in the item “FLAG” by referring to the authentication table. In this example, for the sake of explanation, it is assumed that only a single authenticated PIN(1) indicating that the PIN(1) is authenticated is stored in the authentication table.

If the authentication unit 2060 determines that the authenticated PIN(1) is stored in the authentication table that is stored in the cache, the terminal device 20 acquires the URL(1) that is associated with the authenticated PIN. The terminal device 20 accesses the processing environment 40a in accordance with the acquired URL(1) (Step S107), and reads a script (Step S108). The terminal device 20 generates the access control unit 2061 based on the read script.

The terminal device 20 causes the access control unit 2061 to check the cache and determines whether the authenticated PIN(1) associated with the URL(1) is stored in the authentication table that is stored in the cache (Step S109). If it is determined that the authenticated PIN(1) is stored, the access control unit 2061 permits access to contents that are based on the URL(1). The terminal device 20 accesses the processing environment 40a in accordance with the URL(1) (Step S110). Upon being accessed, the processing environment 40a changes the access destination of the terminal device 20 to, for example, a redirect destination for providing contents (Step S111). The terminal device 20 acquires the contents from the redirect destination (Step S112).

At Step S106 as described above, if the authentication unit 2060 determines that the authenticated PIN(1) is not stored in the authentication table that is stored in the cache, a process at Step S1000 is performed. At Step S1000, the authentication unit 2060 causes the display unit 205 to display an input screen for inputting the PIN(1) in the terminal device 20 (Step S1001).

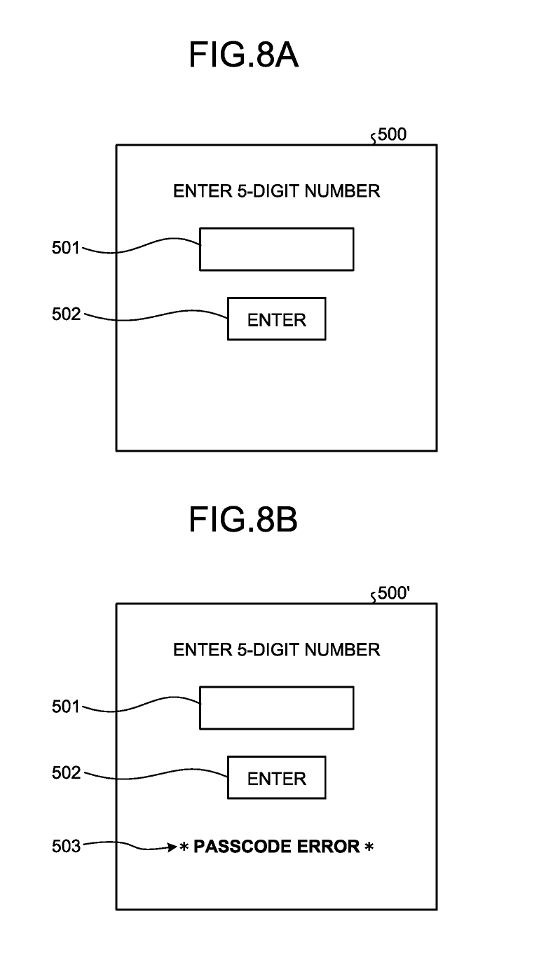

FIGS. 8A and 8B are diagrams each illustrating an example of the input screen that is displayed by the authentication unit 2060 and that is applicable to the first embodiment. In FIG. 8A, an input screen 500 includes an input area 501 for inputting a PIN and an enter button 502. In the example in FIG. 8A, the input area 501 is constructed to input a 5-digit number as a PIN. A user operating the terminal device 20 enters a 5-digit number as a PIN in the input area 501 and then operates the enter button 502.

The authentication unit 2060 acquires, as an input value, the 5-digit number input in the input area 501 in accordance with the operation on the enter button 502. The authentication unit 2060 refers to the authentication table that is stored in the cache, and determines whether the input value matches the PIN(1) that is stored in the item “PIN” (Step S1002). If it is determined that the input value matches the PIN(1) and the value of “0” is stored in the corresponding item “FLAG”, the authentication unit 2060 changes the value of the item “FLAG” to “1”. With this operation, the input value is stored as the authenticated PIN(1) in the authentication table (Step S1003).

At the same time, the authentication unit 2060 notifies the access control unit 2061 that the input value is stored as the authenticated PIN in the authentication table. The access control unit 2061 permits access to a URL that is associated with the input value in the authentication table. Thereafter, the processes from Step S107 as described above are performed.

In contrast, if it is determined that the input value input in the input area 501 is not stored as a value of the item “PIN” in the authentication table, the authentication unit 2060 displays an error message indicating a determination result as indicated as a message 503 in an input screen 500′ in FIG. 8B, and waits until input to the input area 501 is performed again.

Meanwhile, at Step S109 as described above, there may be a case where it is determined that a plurality of authenticated PINs are stored in the cache. In this case, the access control unit 2061 may display a specification screen for specifying a single authenticated PIN from among the plurality of authenticated PINs.

Next, a method of disabling authentication of the authenticated PIN according to the first embodiment will be described. As described above with reference to FIG. 7, when the authenticated PIN is stored in the authentication table, redirection to a specific transition destination is forcibly performed in accordance with the authenticated PIN, in response to transmission of a captured image including a key image. Therefore, in the information processing system la according to the first embodiment, a means for disabling authentication of the authenticated PIN is provided to enable access to different contents, for example.

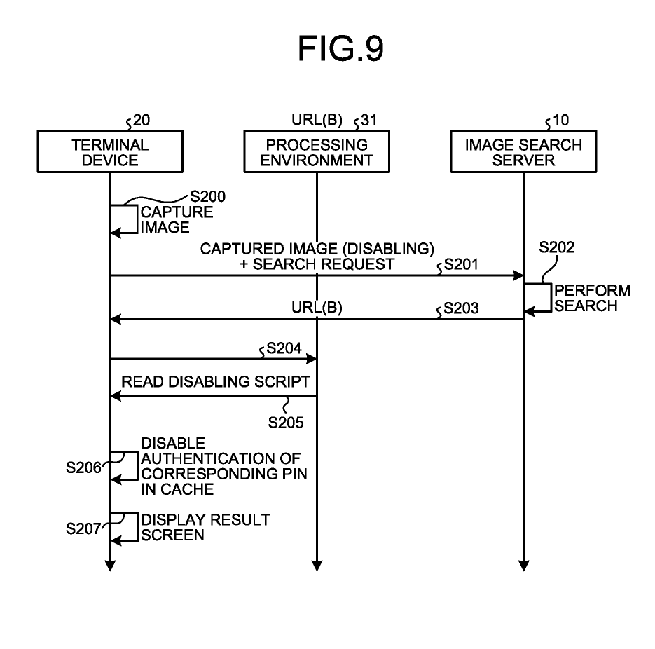

FIG. 9 is a sequence diagram illustrating an example of the process of disabling authentication of the authenticated PIN according to the first embodiment. In FIG. 9, the same components as those illustrated in FIG. 1 as described above are denoted by the same reference signs, and detailed explanation thereof will be omitted. Before the process in the sequence diagram of FIG. 9, a photographic subject including a disabling key image for disabling authentication of the authenticated PIN is prepared.

Here, it is preferable that the disabling key image is arranged on, for example, the same medium as a key image that is used for acquiring contents. For example, when the key image for acquiring contents is published in a magazine, the disabling key image may be published in the same magazine. For another example, when the key image for acquiring contents is included in a poster, the disabling key image may be arranged in the poster.

The user captures an image of a photographic subject including the disabling key image by operating the terminal device 20 (Step S200). The terminal device 20 transmits the captured image including the captured disabling key image and a search request to the image search server 10 (Step S201). The image search server 10 receives the captured image and the search request transmitted from the terminal device 20, performs a search based on the captured image in response to the received search request, and acquires link information that is associated with the disabling key image included in the captured image (Step S202). The link information acquired at this time is the URL(B) that is access destination information on the processing environment 31 for disabling authentication. The image search server 10 returns the acquired link information (URL(B)) to the terminal device 20 (Step S203).

Upon receiving the link information, i.e., the URL(B), from the image search server 10, the terminal device 20 accesses the processing environment 31 in accordance with the received URL(B) (Step S204), and reads a disabling script (Step S205). The disabling script includes the PIN(1), the PIN(2), and the PIN(3) in conformity with a script for authentication.

The terminal device 20 causes the Web application unit 206 to generate the authentication unit 2060 on the basis of the read disabling script. The authentication unit 2060 changes the value of the item “FLAG” of each of the PIN(1), the PIN(2), and the PIN(3) in the authentication table that is stored in the cache to “0”, and disables authentication of the authenticated PIN (Step S206). In the example in Table 1, the item “FLAG” of the PIN(1) is set to the value “1”, so that the value of the item “FLAG” of the PIN(1) is changed to “0”.

The authentication unit 2060 causes the display unit 205 to display a screen for indicating that authentication of the authenticated PIN is disabled (Step S207).

The method of disabling authentication of the authenticated PIN is not limited to the method as illustrated in the sequence diagram of FIG. 9. For example, it is possible to disable authentication of the authenticated PIN by capturing the photographic subject 50 that includes the authentication key image that has been used for authentication of the authenticated PIN. In this case, for example, if it is determined that the authenticated PIN is stored in the authentication table at Step S106 on the basis of the captured image that is captured at Step S100 in FIG. 7 and that includes the authentication key image, the terminal device 20 may cause the display unit 205 to display a designation screen for designating whether to cause the authentication unit 2060 to disable authentication of the authenticated PIN in accordance with user operation.

If it is designated, in the designation screen, that the authentication is disabled in accordance with the user operation, the authentication unit 2060 changes the value of the item “FLAG” corresponding to the authenticated PIN stored in the authentication table to “0”. Further, if it is designated, in the designation screen, that the authentication is not disabled in accordance with the user operation, the terminal device 20 performs the processes from Step S107 in FIG. 7.

First Modification of First Embodiment

Next, a first modification of the first embodiment will be described. In the first modification of the first embodiment, in the terminal device 20, by performing authentication based on an authentication key image and thereafter capturing and transmitting an image that is selected from among a plurality of predetermined images, it is possible to acquire contents corresponding to the selected image. Further, by capturing and transmitting a different image from among the plurality of predetermined images, it is possible to further acquire contents corresponding to the different image.

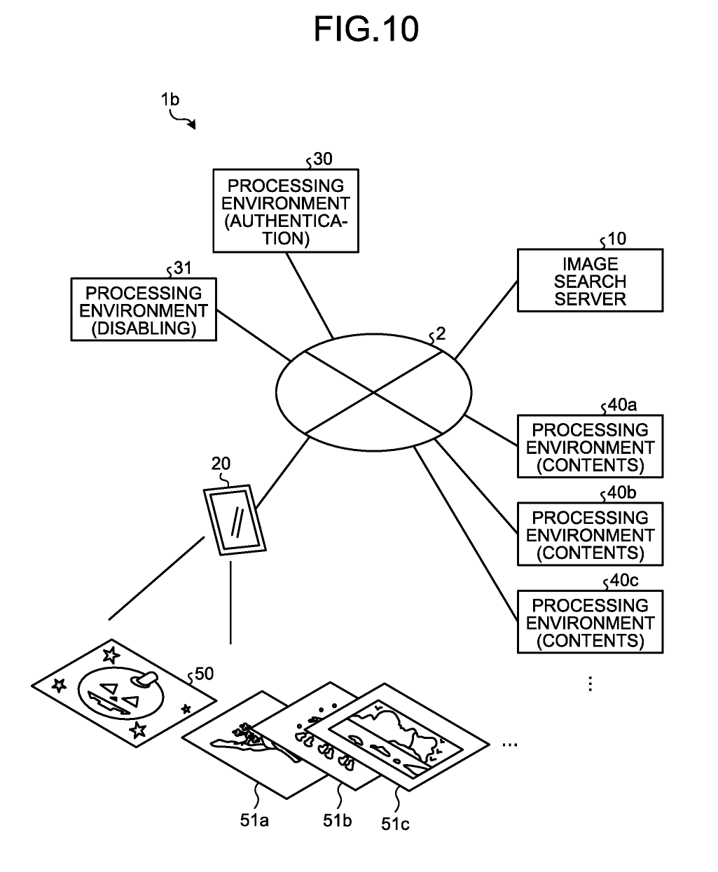

FIG. 10 is a block diagram illustrating an example of a configuration of an information processing system that is applicable to the first modification of the first embodiment. In FIG. 10, the same components as those illustrated in FIG. 1 as described above are denoted by the same reference signs, and detailed explanation thereof will be omitted.

In FIG. 10, an information processing system 1b according to the first modification of the first embodiment has the same configuration as the information processing system 1a illustrated in FIG. 1 in that it includes the image search server 10, the terminal device 20, the processing environments 30 and 31, and the processing environments 40a, 40b, 40c, . . . , all of which are connected to the network 2. However, the information processing system 1b illustrated in FIG. 10 further includes the photographic subject 50 including the authentication key image and photographic subjects 51a, 51b, 51c, . . . including respective key images for access permission to contents. The photographic subjects 51a, 51b, 51c, . . . include key images corresponding to the processing environments 40a, 40b, 40c, . . . , respectively.

Hereinafter, similarly to the above, the processing environments 40a, 40b, 40c, . . . are limited to the three processing environments 40a, 40b, and 40c, and the processing environment 40a will be described as a representative of them for the sake of explanation. In addition, the photographic subjects 51a, 51b, 51c, . . . are also limited to the three photographic subjects 51a, 51b, and 51c in accordance with the processing environments 40a, 40b, and 40c.

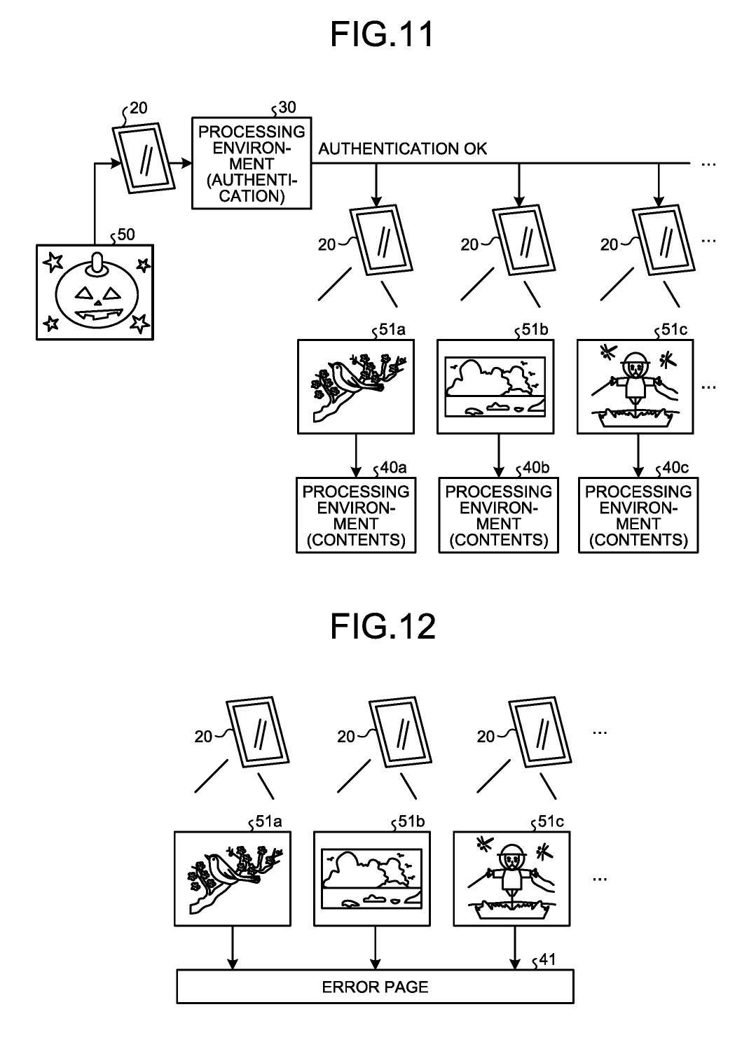

FIG. 11 is a diagram for explaining a process performed by the information processing system 1b according to the first modification of the first embodiment. In FIG. 11, the same components as those illustrated in FIG. 1 as described above are denoted by the same reference signs, and detailed explanation thereof will be omitted. In addition, the image search server 10 is omitted in FIG. 11 for the sake of simplicity.

The terminal device 20 captures an image of the photographic subject 50 that is prepared in advance and that includes the authentication key image, and transmits the captured image and a search request to the image search server 10. The terminal device 20 reads a script by accessing the processing environment 30 in accordance with link information that is retrieved by the image search server 10 in response to the search request, and generates the authentication unit 2060. The authentication unit 2060 refers to the authentication table that is stored in the cache of the terminal device 20 for example, and determines whether an authenticated PIN is stored in the cache of the terminal device 20. If it is determined that the authenticated PIN is stored, the access control unit 2061 permits access to contents based on the image of each of the photographic subjects 51a, 51b, and 51c.

FIG. 12 is a diagram illustrating an example of a process according to the first modification of the first embodiment in the case where the authentication unit 2060 determines that the authenticated PIN is not stored in the cache of the terminal device 20. In this case, when the terminal device 20 captures an image of the photographic subject 51 a for example, the access control unit 2061 refuse access permission to the contents that are based on the image of the photographic subject 51a, and performs redirection to an error page 41 for displaying an error message indicating the refusal for example.

Details of the process according to the first modification of the first embodiment

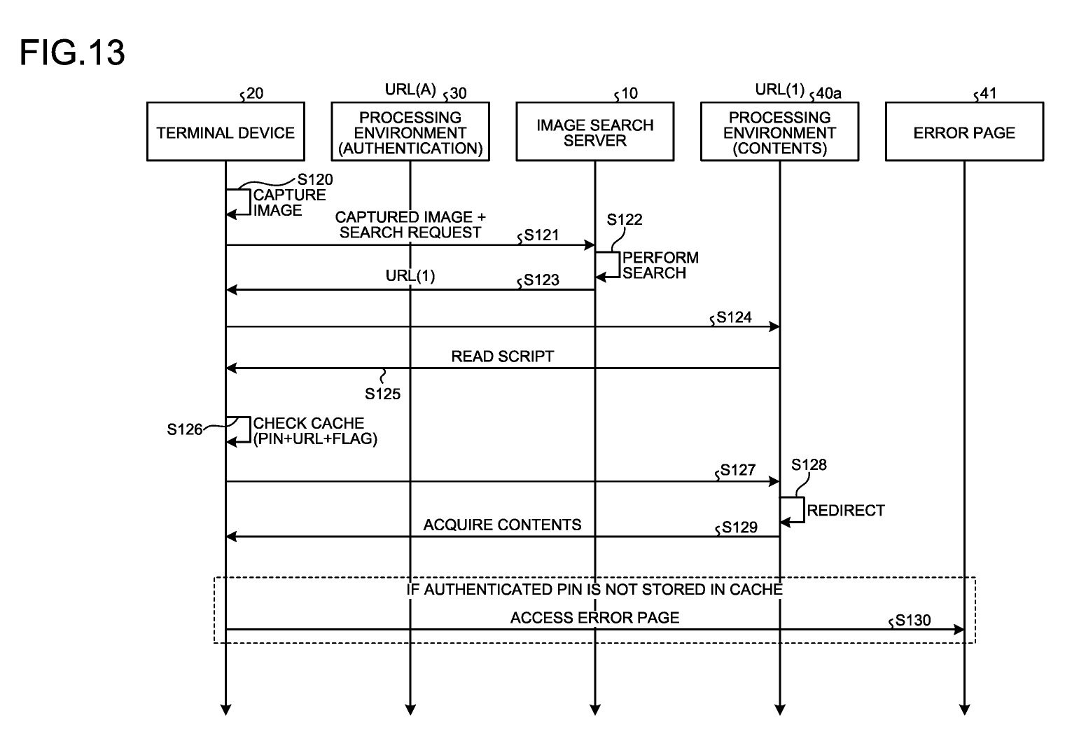

The process according to the first modification of the first embodiment will be described in detail below. FIG. 13 is a sequence diagram illustrating an example of a process performed by the information processing system 1b according to the first modification of the first embodiment. In FIG. 13, the same components as those illustrated in FIG. 1 as described above are denoted by the same reference signs, and detailed explanation thereof will be omitted.

It is assumed that, before the process in the sequence diagram in FIG. 13, an authentication process based on the authentication key image is completed similarly to the processes at Step S100 to Step S106 and Step S1000 in FIG. 7. In other words, the authenticated PIN is already registered in the authentication table that is stored in the cache of the terminal device 20. In this example, as illustrated in Table 1, it is assumed that the PIN(1), the PIN(2), and the PIN(3) are stored in the authentication table, and the PIN(1) is the authenticated PIN.

In FIG. 13, a user captures, for example, an image of the photographic subject 50 including the key image for access permission by operating the terminal device 20 (Step S120), and transmits the captured image and a search request to the image search server 10 (Step S121). The image search server 10 receives the captured image and the search request transmitted from the terminal device 20, performs a search based on the captured image in response to the received search request, and acquires link information that is associated with the key image for access permission included in the captured image (Step S122). It is assumed that the link information acquired at this time is the URL(1) that is access destination information on the processing environment 40a for providing contents corresponding to the photographic subject 51a. The image search server 10 returns the acquired link information (URL(1)) to the terminal device 20 (Step S123).

Upon receiving the link information, i.e., the URL(1), transmitted by the image search server 10, the terminal device 20 accesses the processing environment 40a in accordance with the received URL(1) (Step S124), and reads a script (Step S125). The terminal device 20 generates the authentication unit 2060 and the access control unit 2061 based on the read script. The script for generating the authentication unit 2060 includes the PIN(1) corresponding to the URL(1).

The terminal device 20 causes the authentication unit 2060 to check the cache and determines whether the authenticated PIN(1) indicating that the PIN(1) is authenticated is stored in the authentication table that is stored in the cache (Step S126). If the authentication unit 2060 determines that the authenticated PIN(1) is stored in the authentication table that is stored in the cache, the access control unit 2061 permits the terminal device 20 to access the processing environment 40a.

The terminal device 20 accesses the processing environment 40a in accordance with the URL(1) in response to the access permission (Step S127). Upon being accessed, the processing environment 40a changes the access destination of the terminal device 20 to, for example, a redirect destination for providing contents (Step S128). The terminal device 20 acquires the contents from the redirect destination (Step S129).

In contrast, at Step S126, if the authentication unit 2060 determines that the authenticated PIN(1) is not stored in the authentication table that is stored in the cache, the access control unit 2061 does not permit the terminal device 20 to access the processing environment 40 a. The access control unit 2061 causes the terminal device 20 to access the error page 41 (Step S130). The terminal device 20 displays an error message in accordance with description of the error page 41.

Second Modification of First Embodiment

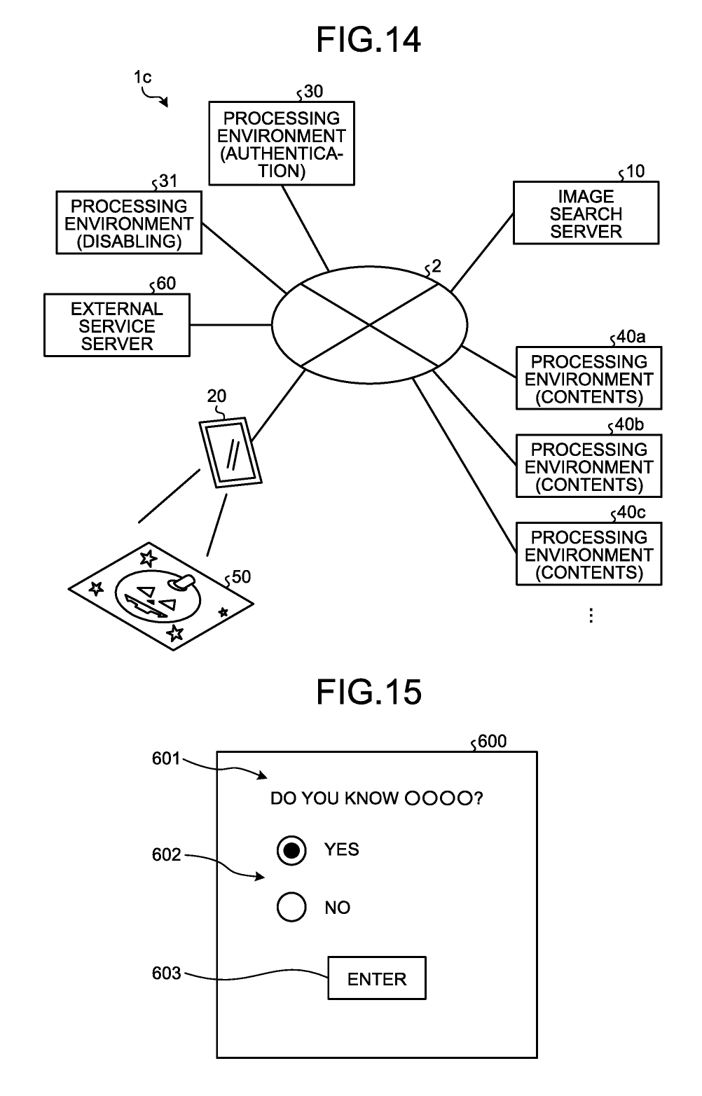

Next, a second modification of the first embodiment will be described. In the second modification of the first embodiment, if the authenticated PIN is not stored in the cache of the terminal device 20, an authentication process is performed via an external service. FIG. 14 is a block diagram illustrating an example of a configuration of an information processing system according to the second modification of the first embodiment. In FIG. 14, the same components as those illustrated in FIG. 1 as described above are denoted by the same reference signs, and detailed explanation thereof will be omitted.

In FIG. 14, an information processing system lc includes the image search server 10, the terminal device 20, the processing environments 30 and 31 for performing authentication and disabling authentication, and the processing environments 40a, 40b, 40c, . . . for providing respective contents, with respect to the network 2. Further, in FIG. 14, an external service server 60 is connected to the network 2. Hereinafter, the processing environments 40a, 40b, 40c, . . . are limited to the three processing environments 40a, 40b, and 40c, and the processing environment 40a will be described as a representative of them for the sake of explanation.

The external service server 60 performs a certain process in response to user operation that is performed via the network 2, for example. In this example, it is assumed that the external service server 60 implements a questionnaire service for collecting information in accordance with the user operation. For example, the external service server 60 provides a questionnaire screen to the terminal device 20 that is connected via the network 2, collects information in response to user operation that is performed in accordance with the questionnaire screen on the terminal device 20, and accumulates and analyzes the information.

FIG. 15 is a diagram illustrating a questionnaire screen 600 that is displayed on the terminal device 20 by the external service server 60. The questionnaire screen 600 includes a message 601 for indicating contents of a questionnaire, an input area 602 for inputting an answer to the questionnaire, and an enter button 603 for transmitting the answer to the questionnaire to the external service server 60. By inputting the answer to the questionnaire in the input area 602 and operating the enter button 603, the answer to the questionnaire based on the contents input in the input area 602 is transmitted to the external service server 60.

Details of a Process According to the Second Modification of the First Embodiment

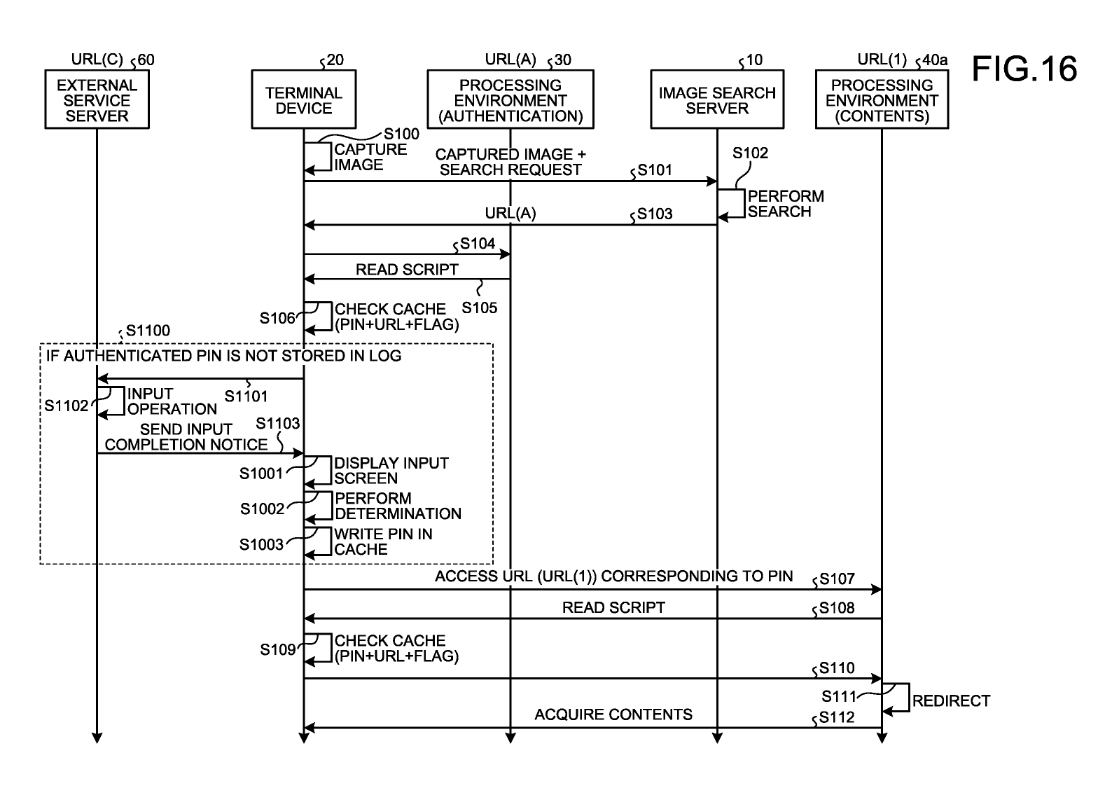

A process according to the second modification of the first embodiment will be described in detail below. FIG. 16 is a sequence diagram illustrating an example of the process performed by the information processing system 1c according to the second modification of the first embodiment. In FIG. 16, the same components as those illustrated in FIG. 7 and FIG. 14 as described above are denoted by the same reference signs, and detailed explanation thereof will be omitted. In addition, it is assumed that a URL(C) is assigned to the external service server 60.

In FIG. 16, processes at Step S100 to Step S106 are the same as the processes at Step S100 to Step S106 in FIG. 7 as described above. Specifically, the terminal device 20 transmits a captured image, which is obtained by capturing an image of the photographic subject 50 including the authentication key image (Step S100), and a search request to the image search server 10 in accordance with user operation (Step S101). The image search server 10 performs a search based on the captured image and the search request transmitted as above, acquires link information (URL(A)) that is associated with the authentication key image included in the captured image and that is access information on the processing environment 30 (Step S102), and transmits the acquired link information to the terminal device 20 (Step S103). Upon receiving the link information from the image search server 10, the terminal device 20 accesses the processing environment 30 in accordance with the URL(A) indicated by the link information (Step S104), reads a script (Step S105), and generates the authentication unit 2060 based on the read script. For example, the script includes the PIN(1), the PIN(2), the PIN(3) and the URL(1), the URL(2), the URL(3) that respectively correspond to the processing environments 40a, 40b, 40c, and includes the URL(C) that is address information on the external service server 60.

The terminal device 20 causes the authentication unit 2060 to check the cache and determines whether the authenticated PIN is stored in the authentication table that is stored in the cache (Step S106).

Processes to be performed when the authentication unit 2060 determines that the authenticated PIN(1) is stored in the authentication table are the same as the processes from Step S107 in FIG. 7. Specifically, the terminal device 20 accesses the processing environment 40a in accordance with the acquired URL(1) (Step S107), and reads a script (Step S108). The terminal device 20 generates the access control unit 2061 on the basis of the read script. The access control unit 2061 checks the cache, and determines whether the authenticated PIN(1) associated with the URL(1) is stored in the authentication table that is stored in the cache (Step S109). If it is determined that the authenticated PIN(1) is stored, the access control unit 2061 permits access to contents based on the URL(1).

The terminal device 20 accesses the processing environment 40a in accordance with the URL(1) (Step S110). Upon being accessed, the processing environment 40a changes the access destination of the terminal device 20 to, for example, a redirect destination for providing contents (Step S111). The terminal device 20 acquires the contents from the redirect destination (Step S112).

At Step S106, if the authentication unit 2060 determines that the authenticated PIN(1) is not stored in the authentication table that is stored in the cache, the process at Step S1100 is performed. At Step S1100, the authentication unit 2060 accesses the external service server 60 in accordance with the script read at Step S105 (Step S1101).

The external service server 60 displays the questionnaire screen 600, which is explained with reference to FIG. 15, on the terminal device 20 in accordance with the access from the terminal device 20, and waits for operation that is performed on the enter button 603 by the terminal device 20 (Step S1102). If the enter button 603 is operated in the terminal device 20 and an answer to the questionnaire is received from the terminal device 20, the external service server 60 sends an input completion notice indicating that input to the questionnaire screen 600 is completed to the terminal device 20 (Step S1103).

Upon receiving the input completion notice from the external service server 60, the access control unit 2061 of the terminal device 20 causes the display unit 205 to display the input screen 500 (see FIGS. 8A and 8B) for inputting the PIN(1) (Step S1001). The authentication unit 2060 acquires, as an input value, a 5-digit number that is input to the input area 501 in accordance with operation on the enter button 502 of the input screen 500, and if it is determined that the input value matches the PIN(1) that is stored in the item “PIN” on the basis of the authentication table and if it is determined that the value of the corresponding item “FLAG” is “0” (Step S1002), the authentication unit 2060 changes the value of the item “FLAG” to “1” and stores the input value as the authenticated PIN(1) in the authentication table (Step S1003). Thereafter, the terminal device 20 performs the processes from Step S107.

The information processing system lc according to the second modification of the first embodiment is able to provide contents based on the key image in cooperation with services provided by the external service server 60.

### Second Embodiment

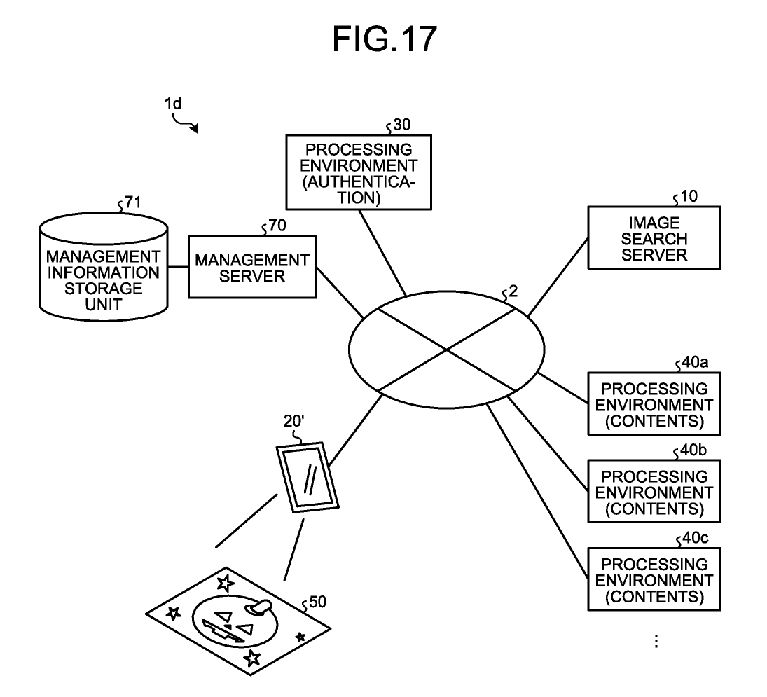

Next, a second embodiment will be described. The second embodiment is an example of controlling access to the contents by using identification information for identifying each of the terminal devices 20. FIG. 17 is a block diagram illustrating an example of a configuration of the information processing system according to the second embodiment. In FIG. 17, the same components as those illustrated in FIG. 1 as described above are denoted by the same reference signs, and detailed explanation thereof will be omitted.

In FIG. 17, an information processing system ld according to the second embodiment further includes a management server 70 and a management information storage unit 71, in addition to the components of the information processing system 1a according to the first embodiment as illustrated in FIG. 1. The management information storage unit 71 functions as an authentication information managing unit for storing management information for performing authentication using a PIN with respect to each of terminal devices 20′. The terminal device 20′ further includes a configuration related to the identification information, in addition to the components of the terminal device 20 according to the first embodiment.

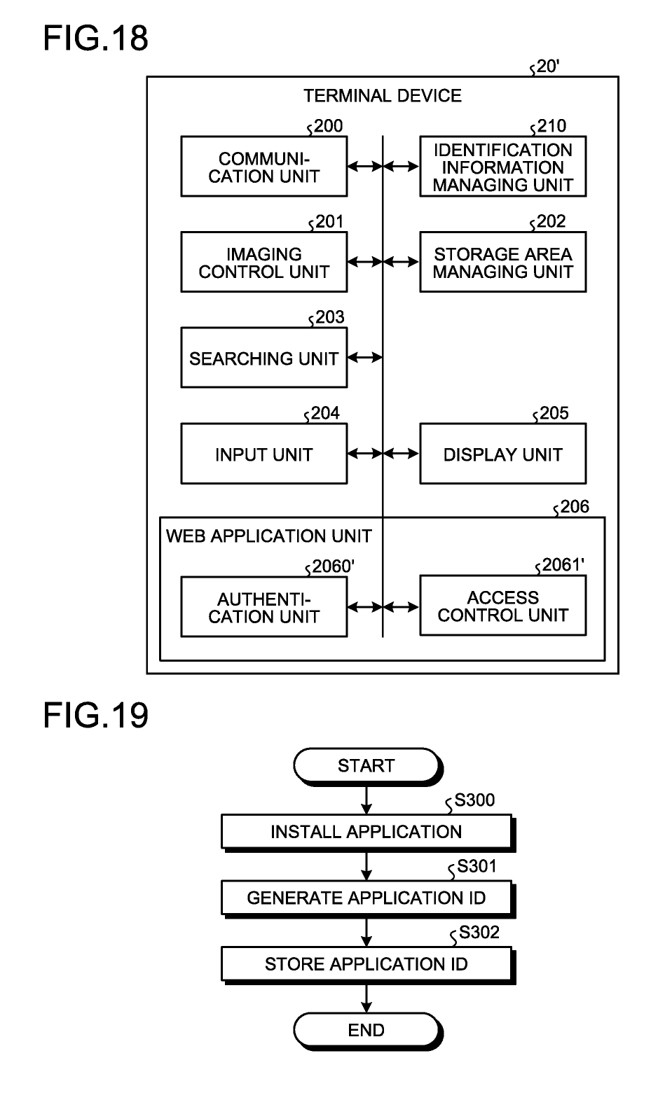

FIG. 18 is a block diagram illustrating an example of a configuration of the terminal device 20′ according to the second embodiment. In FIG. 18, the terminal device 20′ further includes an identification information managing unit 210, in addition to the components of the terminal device 20 according to the first embodiment as illustrated in FIG. 5. The identification information managing unit 210 generates and manages identification information for identifying the terminal device 20′. Further, each of an authentication unit 2060′ and an access control unit 2061′ requests the management server 70 to check management information, and performs authentication and controls access to contents depending on a check result.

In the second embodiment, an application ID (hereinafter, referred to as an app ID) is used as the identification information for identifying the terminal device 20′. The app ID is identification information for identifying an information processing program that is installed in the terminal device 20′ to use the information processing system ld according to the second embodiment.

The app ID will be described below. The app ID is identification information that is uniquely acquired for the information processing program according to the second embodiment, where the information processing program is installed in and executed by the terminal device 20′. The app ID is associated with the information processing program and is not changeable by the user. Further, the app ID is deleted when the information processing program is deleted (uninstalled) from the terminal device 20′.

In other words, the app ID has a different characteristic from identification information, such as an e-mail address or account information, that is set by a user and that can be arbitrarily changed by the user. Further, the app ID has a different characteristic from identification information, such as an apparatus ID, that is associated with the terminal device 20′ itself and that is not changeable by the user. Furthermore, the app ID is unique to the information processing program installed in the terminal device 20′, and therefore, can be used as identification information on each of the terminal devices 20′ by the information processing system ld that is used by the terminal device 20′.

For example, the app ID is generated when the information processing program is installed in the terminal device 20′, and sets for the terminal device 20′. FIG. 19 is a flowchart illustrating one example of a process of generating the app ID according to the second embodiment. Here, it is assumed that the information processing program is installed in the terminal device 20′ using a dedicated installation program (installer).

The installer is downloaded from, for example, a server (the management server 70 or the like) on the network to the terminal device 20′ via the network 2, and stored in the storage 2004. The CPU 2000 outputs a command for designating execution of installation in accordance with user operation for designating execution of installation on the input device 2006 or in an automated manner with download of the installer. The CPU 2000 loads the installer stored in the storage 2004 on the RAM 2002 and executes the installer in response to the command.

In FIG. 19, at Step S300, the CPU 2000 executes the installer and starts installation of the information processing program in accordance with instructions of the installer. When the installation is started, the CPU 2000 generates and acquires the app ID in accordance with instructions of the installer (Step S301). At this time, the installer determines a method of generating the app ID such that the app ID to be generated has a unique value.

It is possible to generate the app ID using, for example, a random number. As one example, the CPU 2000 may generate the app ID by combining a random number of a predetermined length, a time at which an installation process is started by the installer, and time information indicating a time at which the installer is downloaded. However, the embodiments are not limited to this example, and the CPU 2000 may acquire the time information on the second or smaller time scale in accordance with instructions of the installer and use the time information as it is as the app ID, or it may be possible to generate a random number of an adequate length and use the random number as it is as the app ID.

Then, at subsequent Step S302, the CPU 2000 stores the app ID generated at Step S301 in the storage 2004 or the like. At this time, it is more preferable that the CPU 2000 stores the app ID in the storage 2004 in an encrypted manner or in an invisible manner using a predetermined method such that the app ID is hidden from the user.

Details of the Process According to the Second Embodiment

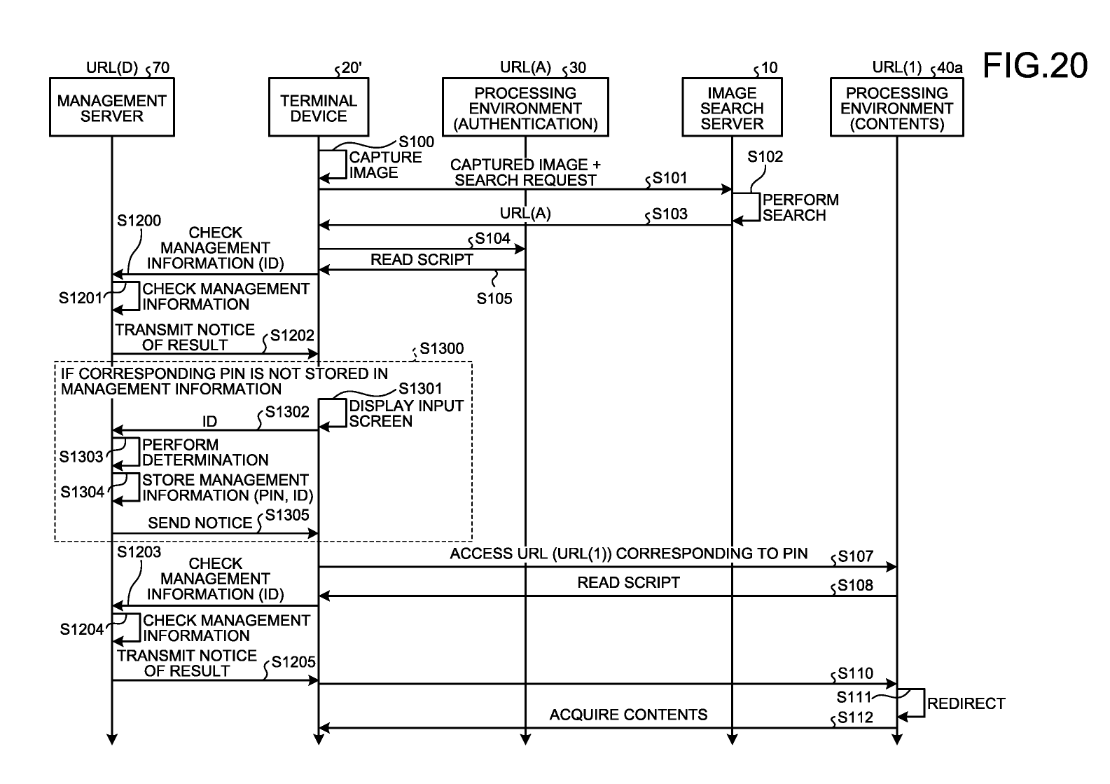

The process according to the second embodiment will be described in detail below. FIG. 20 is a sequence diagram illustrating an example of a process performed by the information processing system ld according to the second embodiment. In FIG. 20, the same components as those illustrated in FIG. 17 as described above are denoted by the same reference signs, and detailed explanation thereof will be omitted.

In FIG. 20, processes from Step S100 to 5105 are the same as the processes at Step S100 to Step S105 in FIG. 7 as described above. Specifically, the terminal device 20′ captures an image of the photographic subject 50 including the authentication key image in accordance with user operation (Step S100). As one example, a predetermined page of a book, such as a magazine, may be used. In this case, it may be possible to provide uncut pages in the magazine, print the authentication key image in the uncut pages, and use the pages as the photographic subject 50. A user is able to capture an image of the photographic subject 50 including the key image by purchasing the magazine and opening the uncut pages.

The terminal device 20′ transmits the captured image that is obtained by capturing an image of the photographic subject 50 including the authentication key image and a search request to the image search server 10 (Step S101). The image search server 10 performs a search based on the captured image and the search request transmitted as above, acquires link information (URL(A)) that is associated with the authentication key image included in the captured image and that is access information on the processing environment 30 (Step S102), and transmits the acquired link information to the terminal device 20′ (Step S103). Upon receiving the link information from the image search server 10, the terminal device 20′ accesses the processing environment 30 in accordance with the URL(A) indicated by the link information (Step S104), reads a script (Step S105), and generates the authentication unit 2060′ based on the read script. For example, the script includes the PIN(1), the PIN(2), the PIN(3) and the URL(1), the URL(2), the URL(3) that respectively correspond to the processing environments 40a, 40b, 40c, and includes a URL(D) that is address information on the management server 70. The URL(D) of the management server 70 may be acquired by the terminal device 20′ at the time of installation of the information processing program, and stored in the storage 2004.

The terminal device 20′ causes the authentication unit 2060′ to transmit the app ID to the management server 70, and issues a query about whether the app ID is stored in association with a PIN in the management information that is stored in the management information storage unit 71 (Step S1200). Table 2 illustrates a configuration example of the management information stored in the management information storage unit 71.

TABLE 2

| PIN | URL | APP ID |
|---|---|---|
| PIN(1) | URL(1) | ID(1) |
| PIN(2) | URL(2) | ID(2) |
| PIN(3) | URL(3) | — |
| . | . | . |
| . | . | . |
| . | . | . |

As illustrated in Table 2, the management information according to the second embodiment is constituted as a table that contains an item “PIN” and an item “URL” corresponding to those of the authentication table illustrated in Table 1, and further contains an item “app ID”. Among these items, the item “PIN” and the item “URL” are the same as the corresponding items in Table 1. The item “app ID” stores therein an app ID that is transmitted from the terminal device 20′. If a value is not stored in the item “app ID”, it is indicated that a PIN stored in the corresponding item “PIN” is not authenticated with respect to the app ID (the terminal device 20′).

In the example of Table 2, as the management information, the PIN(1), the PIN(2), and the PIN(3) are stored in the item “PIN”, and the URL(1), the URL(2), and the URL(3) are stored in the item “URL” in association with the PIN(1), the PIN(2), and the PIN(3), respectively. Further, an ID(1) and an ID(2) are stored in the item “app ID” in association with the PIN(1) and the PIN(2), which indicates that the PIN(1) and the PIN(2) are already authenticated. In contrast, a value corresponding to the PIN(3) is not stored in the item “app ID”, which indicates that the PIN(3) is not authenticated.

The management server 70 checks the management information storage unit 71 in response to the query that is issued by the terminal device 20′ at Step S1200, and determines whether the app ID transmitted from the terminal device 20′ is stored in the management information (Step S1201). If it is determined that the app ID is stored in the management information, the management server 70 transmits notice of a determination result to the terminal device 20′ (Step S1202). At this time, the management server 70 includes, in the notice, the authenticated PIN(1) and the URL(1) that are associated with the app ID in the management information, and transmits the notice to the terminal device 20′. The notice is received by the terminal device 20′ and sent to the authentication unit 2060′.

Processes to be performed when the authentication unit 2060′ receives the notice transmitted from the management server 70 are the same as the processes from Step S107 in FIG. 7. Specifically, the terminal device 20′ accesses the processing environment 40a in accordance with the acquired URL(1) (Step S107), and reads a script (Step S108). The terminal device 20′ generates the access control unit 2061′ based on the read script.

The access control unit 2061′ transmits the app ID to the management server 70, and issues a query about whether an authenticated PIN associated with the app ID is stored as log information in the management information storage unit 71 (Step S1203). The management server 70 checks the management information stored in the management information storage unit 71 in response to the query, and determines whether the app ID transmitted from the terminal device 20′ is stored (Step S1204). If it is determined that the app ID is stored, the management server 70 includes, in notice of a determination result, the authenticated PIN and the URL (assumed as the PIN(1) and the URL(1)) that are associated with the app ID in the management information, and transmits the notice to the terminal device 20′ (Step S1205). The notice is received by the terminal device 20′ and sent to the access control unit 2061′.

Upon receiving the notice, the access control unit 2061′ permits access to contents that are based on the URL(1) included in the notice. The terminal device 20′ accesses the processing environment 40a in accordance with the URL(1) (Step S110). Upon being accessed, the processing environment 40a changes the access destination of the terminal device 20′ to, for example, a redirect destination for providing contents (Step S111). The terminal device 20′ acquires the contents from the redirect destination (Step S112).

If the management server 70 determines that the log information corresponding to the app ID is not stored at Step S1201, and if the terminal device 20′ receives the notice of the result indicating the determination (Step S1202), the process at Step S1300 is performed. At Step S1300, the authentication unit 2060′ causes the display unit 205 to display the input screen 500 for inputting the PIN(1) (Step S1301).

The authentication unit 2060′ acquires, as an input value, a 5-digit number that is input to the input area 501 in accordance with operation on the enter button 502, transmits the acquired input value and the app ID to the management server 70, and sends a query about whether a PIN corresponding to the input value is stored as the management information (Step S1302). The management server 70 checks the management information stored in the management information storage unit 71 in response to the query, and determines whether the PIN is stored as the management information (Step S1303). If the PIN is not stored, the result is error, and the management server 70 returns an error notice to the terminal device 20′.

If it is determined that the PIN is stored as the management information, the management server 70 stores the app ID that is transmitted from the terminal device 20′ in the management information in association with the PIN (Step S1304). With this configuration, the PIN is handled as an authenticated PIN that is authenticated with respect to the app ID. The management server 70 notifies the terminal device 20′ that the input value transmitted from the terminal device 20′ is stored, as the authenticated PIN, in the management information in association with the app ID of the terminal device 20′ (Step S1305).

Upon receiving the notice that is transmitted from the management server 70 at Step S1305, the terminal device 20′ performs the processes from Step S107, accesses the processing environment 40a for example, and acquires contents.

In this manner, in the information processing system ld according to the second embodiment, the authentication process using a PIN is performed by using the app ID with which the terminal device 20′ can be identified. Therefore, it is possible to manage authentication using a PIN for each of the terminal devices 20′ (for each of information processing programs). For example, it is possible to easily set an expiration date of authentication using a PIN, for each of the terminal devices 20′.

Furthermore, according to the information processing system ld of the second embodiment, it is possible to accumulate information in the management server 70 while identifying each of the terminal devices 20′, so that it is possible to acquire more detailed accumulated information.

Meanwhile, in the second embodiment, the management server 70 disables authentication of a PIN in response to a disabling request transmitted from the terminal device 20′. For example, the terminal device 20′ captures an image of a photographic subject including a disabling key image, and transmits the captured image and a search request to the image search server 10. The terminal device 20′ accesses the processing environment 31 in response to the search request and reads a disabling script. The terminal device 20′ transmits the app ID and a disabling request to the management server 70 in accordance with the disabling script. The management server 70 deletes the app ID from the management information that correspond to the app ID and that is stored in the management information storage unit 71, in accordance with the app ID and the disabling request transmitted from the terminal device 20′.

The embodiments are not limited to the above-described example, and it may be possible to disable authentication of a PIN by capturing an image of the photographic subject 50 that includes the authentication key image used for authenticating a PIN. As one example, when the app ID that is transmitted from the terminal device 20′ in accordance with the captured image that is captured at Step S100 in FIG. 20 and that includes the authentication key image is included in the management information stored in the management information storage unit 71 for example, the management server 70 gives notice of this to the terminal device 20′. The terminal device 20′ that has received the notice causes the display unit 205 to display a designation screen for designating whether to disable authentication of the PIN that is associated with the app ID in accordance with user operation.

First Modification of Second Embodiment

Next, a first modification of the second embodiment will be described. The first modification of the second embodiment corresponds to the first modification of the first embodiment as described above, and is an example in which the terminal device 20′ performs, by using the app ID, a process of performing authentication based on the authentication key image and thereafter capturing and transmitting an image that is selected from among a plurality of predetermined images to thereby be able to acquire contents corresponding to the selected image, and a process of capturing and transmitting a different image from among the plurality of predetermined images to thereby be able to acquire contents corresponding to the different image.

The information processing system according to the first modification of the second embodiment further includes the photographic subjects 51a, 51b, 51c, . . . as illustrated in FIG. 10, each including a key image for access permission to contents, in addition to the components of the information processing system ld illustrated in FIG. 17.

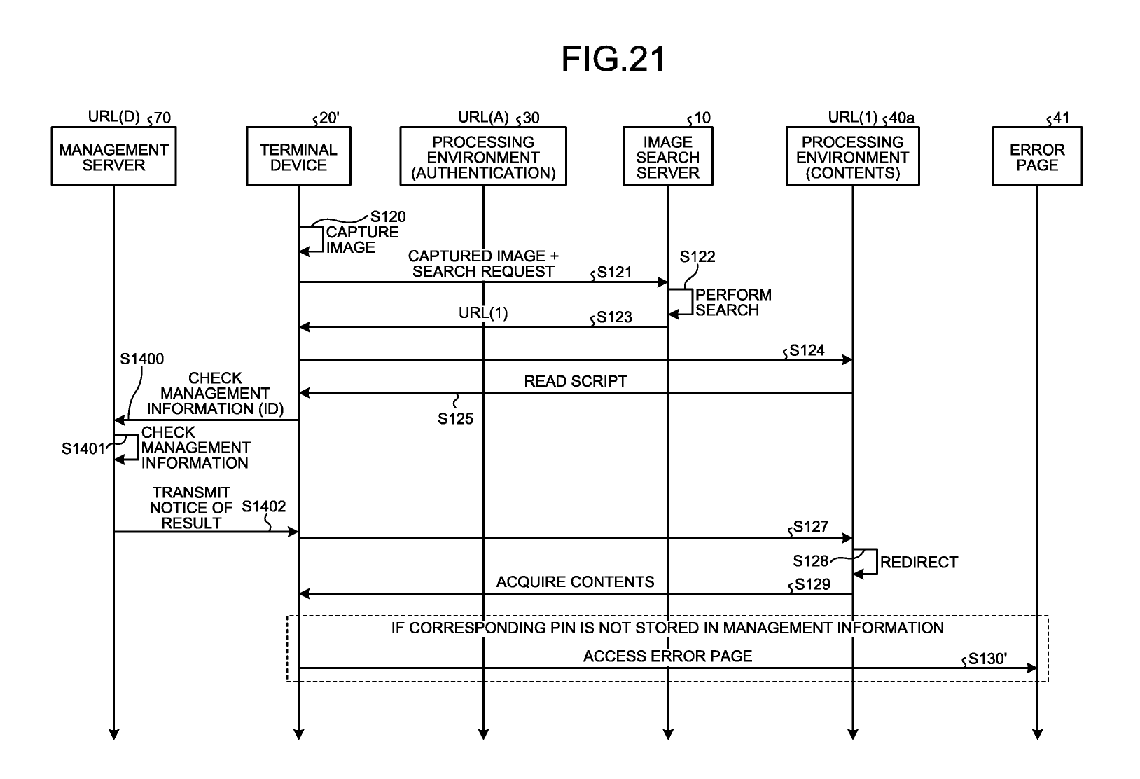

FIG. 21 is a sequence diagram illustrating an example of a process performed by the information processing system according to the first modification of the second embodiment. In FIG. 21, the same components as those illustrated in FIG. 17 and FIG. 13 as described above are denoted by the same reference signs, and detailed explanation thereof will be omitted.

It is assumed that, before the process in the sequence diagram illustrated in FIG. 21, an authentication process based on the authentication key image is completed through the same processes as those at Step S100 to Step S105, Step S1200 to Step S1202, and Step S1300 in FIG. 20. Specifically, the management information, in which the app ID (for example, the ID(1)) transmitted from the terminal device 20′ is associated with a predetermined PIN (for example, the PIN(1)), is already stored in the management information storage unit 71 (see Table 2).

In FIG. 21, a user captures, for example, an image of the photographic subject 51 a including a key image for access permission (see FIG. 10) by operating the terminal device 20′ (Step S120), and transmits the captured image and a search request to the image search server 10 (Step S121). The image search server 10 receives the captured image and the search request transmitted from the terminal device 20′, performs a search based on the captured image in response to the received search request, and acquires link information that is associated with the key image for access permission included in the captured image (Step S122). It is assumed that the link information acquired at this time is the URL(1) that is access destination information on the processing environment 40a for providing contents corresponding to the photographic subject 51 a. The image search server 10 returns the acquired link information (URL(1)) to the terminal device 20′ (Step S123).

Upon receiving the link information, i.e., the URL(1), transmitted from the image search server 10, the terminal device 20′ accesses the processing environment 40a in accordance with the received URL(1) (Step S124), and reads a script (Step S125). The terminal device 20′ generates the authentication unit 2060′ and the access control unit 2061′ based on the read script. The script for generating the authentication unit 2060′ includes the PIN(1) corresponding to URL(1).

The terminal device 20′ causes the authentication unit 2060′ to transmit the app ID to the management server 70, and sends a query about whether the app ID is stored in association with the PIN in the management information that is stored in the management information storage unit 71 (Step S1400).

The management server 70 checks the management information storage unit 71 in response to the query that is issued by the terminal device 20′ at Step S1400, and determines whether the app ID transmitted from the terminal device 20′ is stored in the management information (Step S1401). If it is determined that the app ID is stored in the management information, the management server 70 includes, in notice of a determination result, the authenticated PIN(1) and the URL(1) that are associated with the app ID in the management information, and transmits the notice to the terminal device 20′ (Step S1402). The notice is received by the terminal device 20′ and sent to the access control unit 2061′ via the authentication unit 2060′. The access control unit 2061′ permits the terminal device 20′ to access the processing environment 40a in accordance with the notice.

The terminal device 20′ accesses the processing environment 40a in accordance with the URL(1) in response to the access permission (Step S127). Upon being accessed, the processing environment 40a changes the access destination of the terminal device 20′ to, for example, a redirect destination for providing contents (Step S128). The terminal device 20′ acquires the contents from the redirect destination (Step S129).

In contrast, at Step S1402, if the terminal device 20′ receives, from the management server 70, notice indicating that the app ID is not stored in the management information, the access control unit 2061′ refuses access permission to the processing environment 40a. The access control unit 2061′ causes the terminal device 20′ to access the error page 41 (Step S130′). The terminal device 20′ displays an error message in accordance with description in the error page 41.

Second Modification of Second Embodiment

Next, a second modification of the second embodiment will be described. The second modification of the second embodiment corresponds to the second modification of the first embodiment as described above, and an authentication process is performed via an external service when the app ID of the terminal device 20′ is not stored as the management information in the management information storage unit 71.

An information processing system according to the second modification of the second embodiment further includes the external service server 60 as illustrated in FIG. 14, in addition to the components of the information processing system ld illustrated in FIG. 17. Processes performed by the information processing system include, at Step S1300 in FIG. 20, the processes at Step S1101 to Step S1103 in FIG. 16, before the input screen is displayed at Step S1301. In this case, at Step S1101, the terminal device 20′ further transmits the app ID to the external service server 60, so that the external service server 60 is able to perform an aggregation process for each of the terminal devices 20′.

The embodiments and the modifications of the embodiments as described above are preferred embodiments of the present invention, but the present invention is not limited to the embodiments and the modifications as described above, and various modifications are applicable within the scope not departing from the gist of the present invention.

According to the present invention, it is possible to provide different information based on common information.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A terminal device comprising circuitry configured to perform:
transmitting a captured image to a search device configured to acquire link information associated with an image based on the image;
managing a predetermined storage area of a memory configured to store data;
receiving the link information transmitted from the search device in accordance with the captured image;
authenticating including referring to the predetermined storage area in accordance with the link information received at the receiving, to determine whether authenticated authentication information is stored in the predetermined storage area; and
access-controlling including permitting access to predetermined information in response to determination, at the authenticating, that the authenticated authentication information is stored in the predetermined storage area.

2. The terminal device according to claim 1, wherein the circuitry is configured to perform, at the authenticating, in response to determination that the authenticated authentication information is not stored in the predetermined storage area, displaying an input screen for allowing a user to input a value, and when an input value input in accordance with the input screen matches a predetermined value, storing the input value as the authenticated authentication information in the predetermined storage area.

3. The terminal device according to claim 1, wherein the circuitry is configured to perform, at the access-controlling, permitting access to the predetermined information depending on the authenticated authentication information.

4. The terminal device according to claim 1, wherein the circuitry is configured to perform, at the access-controlling, referring to the predetermined storage area in accordance with the link information received at the receiving, and in response to determination that the authenticated authentication information is stored in the predetermined storage area, permitting access to an access destination indicated by the link information as the predetermined information.

5. The terminal device according to claim 1, wherein the circuitry is configured to, at the authenticating, in response to receiving, at the receiving, the link information transmitted from the search device in accordance with the captured image obtained by imaging a disabling photographic subject, disabling authentication of the authenticated authentication information stored in the predetermined storage area and associated with the disabling photographic subject in advance.

6. The terminal device according to claim 1, wherein the circuitry is configured to perform, at the authenticating, in response to determination that the authenticated authentication information is stored in the predetermined storage area, providing a designation screen for designating whether to disable authentication of the authenticated authentication information.

7. The terminal device according to claim 2, wherein the circuitry is configured to perform, at the authenticating, in response to determination that the authenticated authentication information is not stored in the predetermined storage area, accessing an access destination determined in advance, and displaying the input screen in accordance with notice from the access destination.

8. The terminal device according to claim 1, the circuitry is further configured to perform communication via a network, wherein
the circuitry is configured to perform, at the communication, loading a program distributed via the network, to perform the authenticating and the access-controlling.

9. A method comprising:
transmitting a captured image to a search device configured to acquire link information associated with an image based on the image;
managing a predetermined storage area of a memory configured to store data;
receiving the link information transmitted from the search device in accordance with the captured image;
authenticating including referring to the predetermined storage area in accordance with the link information received at the receiving, to determine whether authenticated authentication information is stored in the predetermined storage area; and
controlling including permitting access to predetermined information in response to determination, at the authenticating, that the authenticated authentication information is stored in the predetermined storage area.

10. An information processing system comprising:
a search device; and
a terminal device,
the search device comprising circuitry configured to perform searching including acquiring link information associated with an image based on the image, and transmitting the acquired link information to a transmission source of the image,
the terminal device comprising circuitry configured to perform:
transmitting a captured image to the search device;
managing a predetermined storage area of a memory configured to store data;
receiving the link information transmitted from the search device in accordance with the captured image;
authenticating including referring to the predetermined storage area in accordance with the link information received at the receiving, to determine whether authenticated authentication information is stored in the predetermined storage area; and
access-controlling including permitting access to predetermined information in response to determination, at the authenticating, that the authenticated authentication information is stored in the predetermined storage area.
